(19) United States
(12) Patent Application Publication
(10) Pub. No.: US 2023/0241770 A1
(43) Pub. Date: Aug. 3, 2023

(54) CONTROL DEVICE, CONTROL METHOD AND STORAGE MEDIUM

(71) Applicant: NEC Corporation, Minato-ku, Tokyo (JP)

(72) Inventors: Takehiro ITOU, Tokyo (JP); Hiroyuki OYAMA, Tokyo (JP)

(73) Assignee: NEC Corporation, Minato-ku, Tokyo (JP)

(21) Appl. No.: 18/015,621

(22) PCT Filed: Jul. 14, 2020
(86) PCT No.: PCT/JP2020/027311

§ 371 Date: Jan. 11, 2023

(51) Int. Cl. B25J 9/16; G05B 19/4155

(52) U.S. Cl. CPC B25J 9/163; G05B 19/4155; G05B 2219/50391

(57) ABSTRACT

The control device 200X functionally includes an operation policy acquisition means 21X and a policy combining means 23X. The operation policy acquisition means 21X is configured to acquire an operation policy relating to an operation of a robot. The operation policy acquisition means 21X is configured to acquire an operation policy relating to an operation of a robot.

### TECHNICAL FIELD

The present disclosure relates to a control device, a control method, and a storage medium for performing control relating to a robot.

### BACKGROUND ART

The application of robots is expected in various fields due to the decrease in the labor population. The substitution of the manual labor by a robot manipulator which can perform pick-and-place has been already attempted in logistics industries in which handling of heavy goods is necessary, and in food factories in which a simple work is repeated. However, current robots specialize in accurately repeating a specified motion, and it is difficult to set up routine motions in an environment that there are many moving obstacles such as an environment which needs complex handling of an undefined object or an environment which causes worker's interference in a narrow workspace. Therefore, even though the shortage of workers is apparent, the introduction of robots to restaurant and supermarket industries has not been achieved.

In order to develop robots that can cope with such complicated situations, some approaches have been proposed in which robots are made to learn the constraints of the environment by themselves and the appropriate operations in accordance with the given situation. Patent Literature 1 discloses a method of acquiring operations of a robot using deep reinforcement learning. Patent Literature 2 discloses a method of acquiring, based on the deviation from the target position of the reaching, operation parameters relating to the reaching by learning. Patent Literature 3 discloses a method of acquiring passing points of the reaching operation by learning. Further, Patent Literature 4 discloses a method of learning the operation parameters of a robot using Bayesian optimization.

### CITATION LIST

### Patent Literature

Patent Literature 1: JP 2019-529135A
Patent Literature 2: JP 2020-044590A
Patent Literature 3: JP 2020-028950A
Patent Literature 4: JP 2019-111604A

### SUMMARY

### Problem to be Solved

In Patent Literature 1, a method of acquiring operations of a robot using deep learning and reinforcement learning has been proposed. However, generally in deep learning, it is necessary to repeat sufficiently many training until the convergence of the parameters, and also in reinforcement learning, the number of trainings required increases with the increase in the complexity of the environment. Especially, regarding reinforcement learning while operating a real robot, it is not realistic from the viewpoints of learning time and number of trials. In addition, in reinforcement learning, there is an issue that it is difficult to apply the learned policy to the case in a different environment, because an action with the highest reward is selected based on a set of the environment state and possible robot actions at that time. Therefore, in order for a robot to perform autonomously adaptive operation in a real environment, it is required to reduce the learning time and to acquire general-purpose operation.

In Patent Literatures 2 and 3, a method of acquiring an operation using learning has been proposed in limited operations such as reaching. However, the learned operations are limited and simple operations. In Patent Literature 4, a method of learning the operation parameters of a robot using Bayesian optimization has been proposed. However, it does not disclose a method for causing a robot to learn complicated operations.

In view of the above described issues, it is therefore an example object of the present disclosure to provide a control device capable of suitably causing a robot to operate.

### Means for Solving the Problem

In one mode of the control device, there is provided a control device including:

an operation policy acquisition means configured to acquire an operation policy relating to an operation of a robot;

and a policy combining means configured to generate a control command of the robot by combining at least two or more operation policies.

In one mode of the control method, there is provided a control method executed by a computer, the control method including:

acquiring an operation policy relating to an operation of a robot; and

generating a control command of the robot by combining at least two or more operation policies. It is noted that the computer may be configured by plural devices.

In one mode of the storage medium, there is provided a storage medium storing a program executed by a computer, the program causing the computer to:

acquire an operation policy relating to an operation of a robot; and

generate a control command of the robot by combining at least two or more operation policies.

### Effect

An example advantage according to the present invention is to suitably cause a robot to operate.

### BRIEF DESCRIPTION OF THE DRAWINGS

FIG. 1 is a block diagram showing a schematic configuration of a robot system according to a first example embodiment.

FIG. 2A is an example of a hardware configuration of a display device.

FIG. 2B is an example of a hardware configuration of a robot controller.

FIG. 3 is an example of a flowchart showing the operation of the robot system according to the first example embodiment.

FIG. 4 is a diagram illustrating an example of a peripheral environment of the robot hardware.

FIG. 5 illustrates an example of an operation policy designation screen image displayed by the policy display unit in the first example embodiment.

FIG. 6 illustrates an example of an evaluation index designation screen image to be displayed by an evaluation index display unit in the first example embodiment.

FIG. 7A illustrates a first peripheral view of an end effector in the second example embodiment.

FIG. 7B illustrates a second peripheral view of an end effector in the second example embodiment.

FIG. 8 illustrates a two-dimensional graph showing the relation between the distance between the point of action and the position of a cylindrical object to be grasped and the state variables in the second operation policy corresponding to the degree of opening of the fingers.

FIG. 9 illustrates a diagram in which the learning target parameters set in each trial are plotted.

FIG. 10 illustrates a peripheral view of an end effector during task execution in a third example embodiment.

FIG. 11 illustrates an example of an evaluation index designation screen image to be displayed by the evaluation index display unit in the third example embodiment.

FIG. 12A illustrates a relation between a learning target parameter of the first operation policy and the reward value for the first operation policy in the third example embodiment.

FIG. 12B illustrates a relation between a learning target parameter of the second operation policy and the reward value for the second operation policy in the third example embodiment.

FIG. 13 illustrates a schematic configuration diagram of a control device in a fourth example embodiment.

FIG. 14 illustrates an example of a flowchart indicative of a processing procedure to be executed by the control device in the fourth example embodiment.

### EXAMPLE EMBODIMENTS

### Explanation of Issues

First, in order to facilitate the understanding of the content of the present disclosure, issues to be dealt with in the present disclosure will be described in detail.

In order to acquire adaptive operations according to the environment, a reinforcement learning approach which evaluates the result of an actual operation and which improves the operation is one of the most workable approaches. Here, “operation policy” is a function that generates an operation (motion) from the state. As a substitute for humans, robots are expected to play an active role in various places, and operations desired to be realized by robots are complicated and diverse. However, in order to acquire complicated operation policies, the known enhancement learning requires a very large number of trials. This is because we are trying to acquire the whole picture of the operation policy itself from the reward function and the data based on trial and error.

Here, the robot can operate even if the operation policy itself is a function prepared beforehand by a human. For example, when considering a task “causing the hand to reach the target position” as a simple operation policy, it calculates the acceleration (velocity) of each joint according to inverse kinematics by selecting the target position as the state and selecting a function which generates the attraction of the hand according to the distance from the target position to the hand position as the policy function. Accordingly, it is possible to generate the joint velocity or acceleration to reach the target position. This can also be considered as a kind of the operation policy. In this case, since the state is limited, it is impossible to exhibit adaptability to the environment. For such a simple task, for example, the operation of closing the end effector, the operation of setting the end effector to a desired posture, and the like can be designed in advance. However, predefined simple operation policies alone cannot realize complex operations tailored to the scene.

In addition, since the operation policy is a kind of function determined by the state, the qualitative mode of the operation can be changed by changing the parameters of the function. For example, even if the task “causing the hand to reach the target position” is unchanged, it is possible to change the reaching velocity, the amount of overshoot, and the like by changing the gain and it is also possible to change the main joint to mostly operate by only changing the weight for each joint when solving the inverse kinematics.

Now, it is possible to acquire parameters in accordance with the environment with a relatively small number of trials by defining a reward function that evaluates the operation (behavior) generated by the policy and updating the policy parameters so as to improve the value of the reward function based on a Bayesian optimization or an algorithm a simulator-validated Evolutionary Strategy (ES: Evolution Strategy) algorithm. However, it is generally difficult to design a function corresponding to an operation with some complexity and the same operation is rarely required. Therefore, it is not easy for general workers to determine appropriate policies and reward functions, and it takes a lot of time and costs a lot of money.

The applicant has found out the above-mentioned issues and has also developed an approach for solving the issues. The applicant proposes an approach including steps of preparing in advance and storing, in the system, operation policies which can realize a simple operation and the evaluation indices and merges the combination thereof selected by an worker, and learning appropriate parameters adjusted to the situation. According to this approach, it is possible to suitably generate complicated operations and evaluate the operation results while enabling the worker to cause a robot to learn operations.

Hereinafter, the example embodiments relating to the above approach will be described in detail with reference to the drawings.

### First Example Embodiment

In the first example embodiment, a robot system configured to use a robot arm for the purpose of grasping a target object (e.g., a block) will be described.

(1) System Configuration

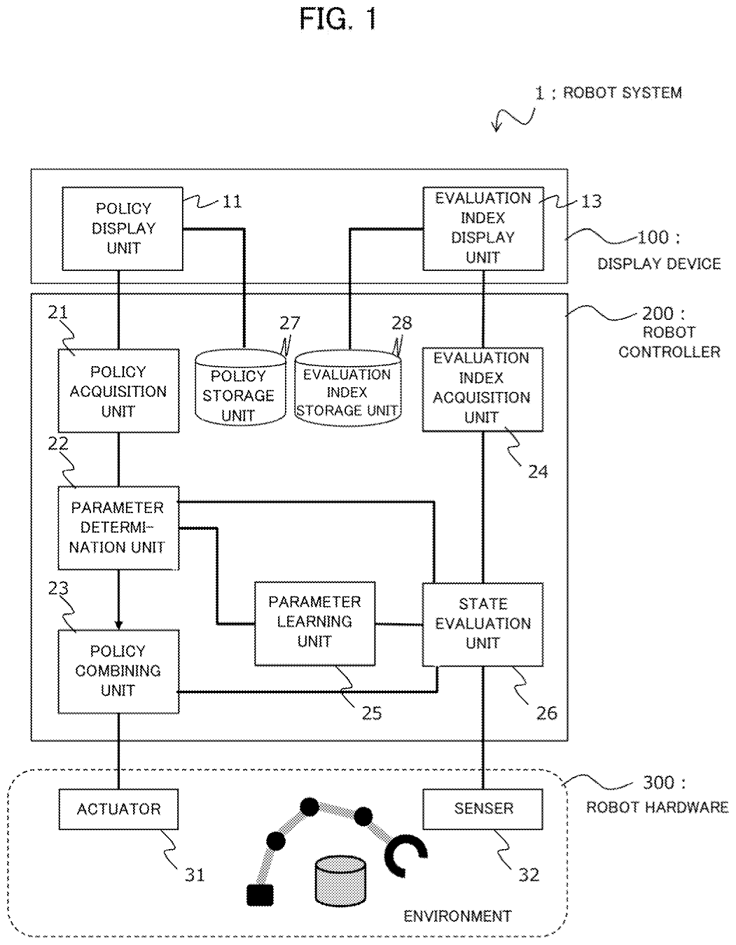

FIG. 1 is a block diagram showing a schematic configuration of a robot system 1 according to the first example embodiment. The robot system 1 according to the first example embodiment includes a display device 100, a robot controller 200, and a robot hardware 300. In FIG. 1, any blocks to exchange data or a timing signal are connected to each other by a line, but the combinations of the blocks and the flow of data in which the data or the timing signal is transferred is not limited to FIG. 1. The same applies to other functional block diagrams described below.

The display device 100 has at least a display function to present information to an operator (user), an input function to receive an input by the user, and a communication function to communicate with the robot controller 200. The display device 100 functionally includes a policy display unit 11 and an evaluation index display unit 13.

The policy display unit 11 receives an input by which the user specifies information on a policy (also referred to as “operation policy”) relating to the operation of the robot. In this case, the policy display unit 11 refers to the policy storage unit 27 and displays candidates for the operation policy in a selectable state. The policy display unit 11 supplies information on the operation policy specified by the user to the policy acquisition unit 21. The evaluation index display unit 13 receives an input by which the user specifies the evaluation index for evaluating the operation of the robot. In this case, the evaluation index display unit 13 refers to the evaluation index storage unit 28, and displays candidates for the evaluation index in a selectable state. The evaluation index display unit 13 supplies the information on the evaluation index specified by the user to the evaluation index acquisition unit 24.

The robot controller 200 controls the robot hardware 300 based on various user-specified information supplied from the display device 100 and sensor information supplied from the robot hardware 300. The robot controller 200 functionally includes a policy acquisition unit 21, a parameter determination unit 22, a policy combining unit 23, an evaluation index acquisition unit 24, a parameter learning unit 25, a condition evaluation unit 26, and a policy storage unit 27.

The policy acquisition unit 21 acquires information on the operation policy of the robot specified by the user from the policy display unit 11. The information on the operation policy of the robot specified by the user includes information specifying a type of the operation policy, information specifying a state variable, and information specifying a parameter (also referred to as the “learning target parameter”) to be learned among the parameters required in the operation policy.

The parameter determination unit 22 tentatively determines the value of the learning target parameter at the time of execution of the operation policy acquired by the policy acquisition unit 21. The parameter determination unit 22 also determines the values of the parameters of the operation policy that needs to be determined other than the learning target parameter. The policy combining unit 23 generates a control command obtained by combining a plurality of operation policies. The evaluation index acquisition unit 24 acquires an evaluation index, which is set by the user, for evaluating the operation of the robot from the evaluation index display unit 13. The state evaluation unit 26 evaluates the operation of the robot based on: the information on the operation actually performed by the robot detected based on the sensor information generated by the sensor 32; the value of the learning target parameter determined by the parameter determination unit 22; and the evaluation index acquired by the evaluation index acquisition unit 24. The parameter learning unit 25 learns the learning target parameter so as to increase the reward value based on the learning target parameter tentatively determined and the reward value for the operation of the robot.

The policy storage unit 27 is a memory to which the policy display unit 11 can refer and stores information on operation policies necessary for the policy display unit 11 to display information. For example, the policy storage unit 27 stores information on candidates for the operation policy, parameters required for each operation policy, candidates for the state variable, and the like. The evaluation index storage unit 28 is a memory to which the evaluation index display unit 13 can refer and stores information on evaluation indices necessary for the evaluation index display unit 13 to display information. For example, the evaluation index storage unit 28 stores user-specifiable candidates for the evaluation index. The robot controller 200 has an additional storage unit for storing various information necessary for the display by the policy display unit 11 and the evaluation index display unit 13 and any other processes performed by each processing unit in the robot controller 200, in addition to the policy storage unit 27 and the evaluation index storage unit 28.

The robot hardware 300 is hardware provided in the robot and includes an actuator 31, and a sensor 32. The actuator 31 includes a plurality of actuators, and drives the robot based on the control command supplied from the policy combining unit 23. The sensor 32 performs sensing (measurement) of the state of the robot or the state of the environment, and supplies sensor information indicating the sensing result to the state evaluation unit 26.

It is noted that examples of the robot include a robot arm, a humanoid robot, an autonomously operating transport vehicle, a mobile robot, an autonomous driving vehicle, an unmanned vehicle, a drone, an unmanned airplane, and an unmanned submarine. Hereinafter, as a representative example, a case where the robot is a robot arm will be described.

The configuration of the robot system 1 shown in FIG. 1 described above is an example, and various changes may be made. For example, the policy acquisition unit 21 may perform display control on the policy display unit 11 with reference to the policy storage unit 27 or the like. In this case, the policy display unit 11 displays information based on the display control signal generated by the policy acquisition unit 21. In the same way, the evaluation index acquisition unit 24 may perform display control on the evaluation index display unit 13. In this case, the evaluation index display unit 13 displays information based on the display control signal generated by the evaluation index acquisition unit 24. In another example, at least two of the display device 100, the robot controller 200, and the robot hardware 300 may be configured integrally. In yet another example, one or more sensors that sense the workspace of the robot separately from the sensor 32 provided in the robot hardware 300 may be provided in or near the workspace, and the robot controller 200 may perform an operation evaluation of the robot based on sensor information outputted by the sensors.

(2) Hardware Configuration

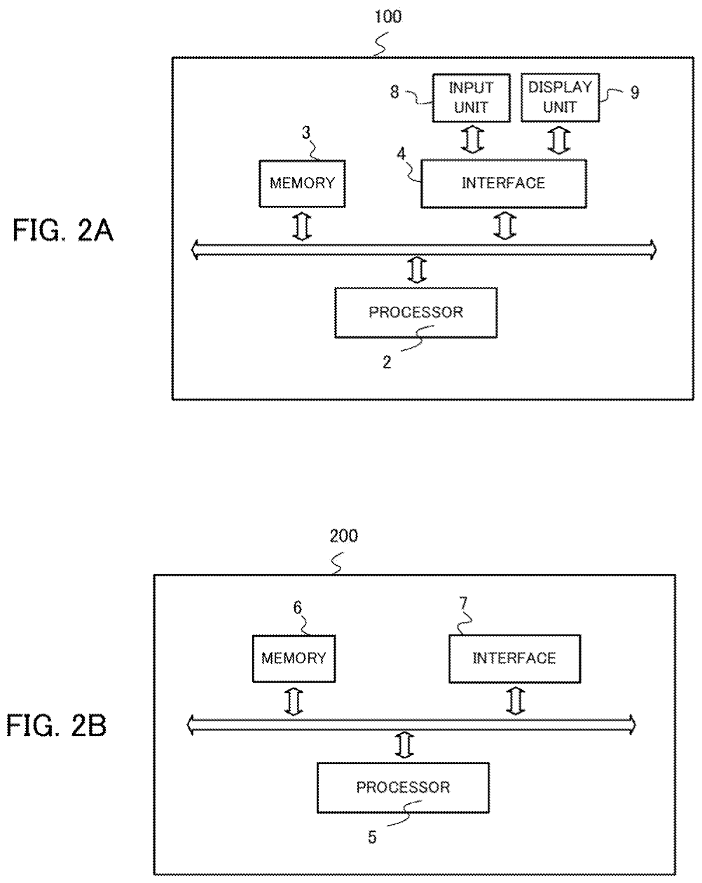

FIG. 2A is an example of a hardware configuration of the display device 100. The display device 100 includes, as hardware, a processor 2, a memory 3, an interface 4, an input unit 8, and a display unit 9. Each of these elements is connected to one another via a data bus.

The processor 2 functions as a controller configured to control the entire display device 100 by executing a program stored in the memory 3. For example, the processor 2 controls the input unit 8 and the display unit 9. The processor 2 is, for example, one or more processors such as a CPU (Central Processing Unit), GPU (Graphics Processing Unit), and a quantum processor. The processor 5 may be configured by a plurality of processors. For example, the processor 2 functions as the policy display unit 11 and the evaluation index display unit 13 by controlling the input unit 8 and the display unit 9.

The memory 3 is configured by various volatile memories such as a RAM (Random Access Memory) and a ROM (Read Only Memory) and a non-volatile memory. Further, the memory 3 stores a program for the display device 100 to execute a process. The program to be executed by the display device 100 may be stored in a storage medium other than the memory 3.

The interface 4 may be a wireless interface, such as a network adapter, for exchanging data with other devices wirelessly, and/or a hardware interface for communicating with other devices. The interface 4 is connected to an input unit 8 and a display unit 9. The input unit 8 generates an input signal according to the operation by the user. Examples of the input unit 8 include a keyboard, a mouse, a button, a touch panel, a voice input device, and a camera for gesture input. Hereafter, a signal generated by the input unit 8 due to a predetermined action (including voicing and gesture) of a user such as an operation of the user is also referred to as “user input”. The display unit 9 displays information under the control of the processor 2. Examples of the display unit 9 include a display and a projector.

The hardware configuration of the display device 100 is not limited to the configuration shown in FIG. 2A. For example, the display device 100 may further include a sound output device.

FIG. 2B is an example of a hardware configuration of the robot controller 200. The robot controller 200 includes a processor 5, a memory 6, and an interface 7 as hardware. The processor 5, the memory 6, and the interface 7 are connected to one another via a data bus.

The processor 5 functions as a controller configured to control the entire robot controller 200 by executing a program stored in the memory 6. The processor 5 is, for example, one or more processors such as a CPU and a GPU. The processor 5 may be configured by a plurality of processors. The processor 5 is an example of a computer. Examples of the processor 5 may include a quantum chip.

The memory 6 is configured by various volatile memories such as a RAM, a ROM and a non-volatile memory. Further, the memory 6 stores a program for the robot controller 200 to execute a process. The program to be executed by the robot controller 200 may be stored in a storage medium other than the memory 6.

The interface 7 is one or more interfaces for electrically connecting the robot controller 200 to other devices. For example, the interface 7 includes an interface for connecting the robot controller 200 to the display device 100, and an interface for connecting the robot controller 200 to the robot hardware 300. These interfaces may include a wireless interface, such as network adapters, for transmitting and receiving data to and from other devices wirelessly, or may include a hardware interface, such as cables, for connecting to other devices.

The hardware configuration of the robot controller 200 is not limited to the configuration shown in FIG. 2B. For example, the robot controller 200 may include an input device, an audio input device, a display device, and/or a sound output device.

Each component of the policy acquisition unit 21, the parameter determination unit 22, the policy combining unit 23, the evaluation index acquisition unit 24, the parameter learning unit 25, and the state evaluation unit 26 described in FIG. 1 can be realized by the processor 5 executing a program, for example. Additionally, the necessary program may be recorded on any non-volatile storage medium and installed as necessary to realize each component. It is noted that at least a part of these components may be implemented by any combination of hardware, firmware, and software, and the like, without being limited to being implemented by software based on a program. At least some of these components may also be implemented by a user programmable integrated circuit such as, for example, a FPGA (field-programmable gate array) and a microcontroller. In this case, the integrated circuit may be used to realize a program functioning as each of the above components. Further, at least a part of the components may be configured by ASSP (Application Specific Standard Produce) or ASIC (Application Specific Integrated Circuit). Thus, each component may be implemented by various hardware. The above is the same in other example embodiments described later. Furthermore, these components may be implemented by a plurality of computers, for example, based on a cloud computing technology.

(3) Details of Operation

(3-1) Operation Flow

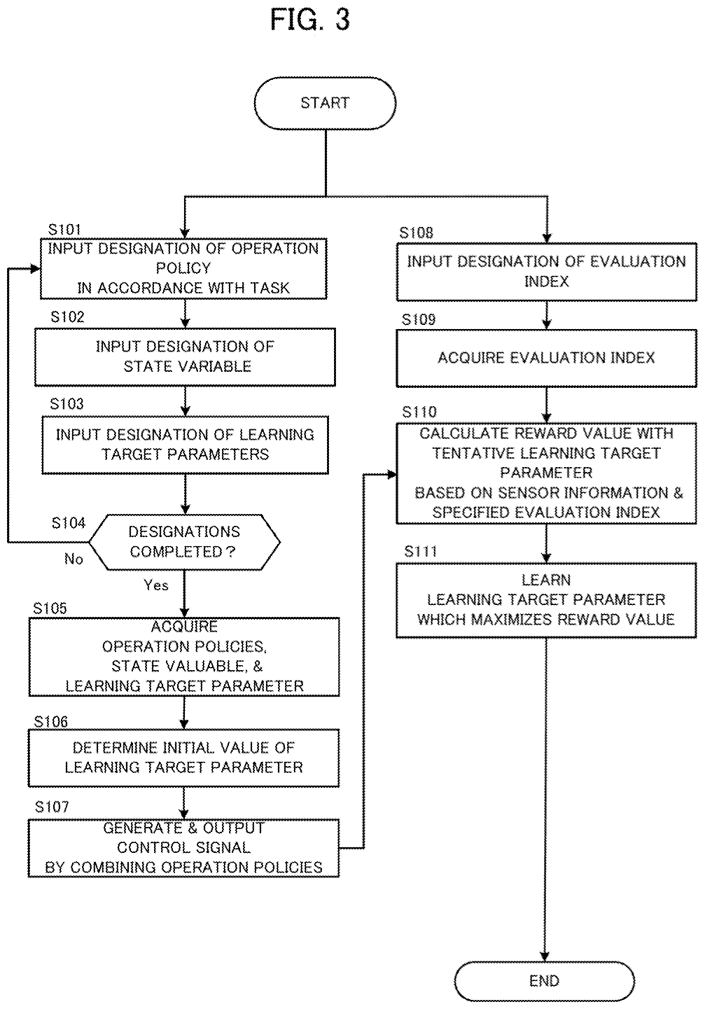

FIG. 3 is an example of a flowchart showing the operation of the robot system 1 according to the first example embodiment.

First, the policy display unit 11 inputs a user input specifying the operation policy suitable for a target task by referring to the policy storage unit 27 (step S101). For example, the policy display unit 11 refers to the policy storage unit 27 and displays, as candidates for the operation policy to be applied, plural types of operation policies that are typical for the target task to thereby receive the input for selecting the type of the operation policy to be applied from among the candidates. For example, the policy display unit 11 displays the candidates that are the types of the operation policy corresponding to attraction, avoidance, or retention, and receives an input or the like specifying the candidate to be used from among them. Details of attraction, retention, and retention are described in detail in the section “(3-2) Detail of Processes at step S101 to step S103”.

Next, by referring to the policy storage unit 27, the policy display unit 11 inputs (receives) an input specifying the state variable or the like in the operation policy whose type is specified at step S101 by the user (step S102). In addition to the state variable, the policy display unit 11 may further allow the user to specify information relating to the operation policy such as a point of action of the robot. In addition, the policy display unit 11 selects the learning target parameter to be learned in the operation policy specified at step S101 (step S103). For example, the information on target candidates of selection for the learning target parameter at step S103 is associated with each type of the operation policy and stored in the policy storage unit 27. Therefore, for example, the policy display unit 11 receives an input for selecting the learning target parameter from these parameters.

Next, the policy displaying unit 11 determines whether or not the designations at step S101 to the step S103 have been completed (step S104). When it is determined that the designations relating to the operation policy have been completed (step S104; Yes), i.e., when it is determined that there is no additional operation policy to be specified by the user, the policy display unit 11 proceeds with the process at step S105. On the other hand, when it is determined that the designations relating to the operation policy have not been completed (step S104; No), i.e., when it is determined that there is an operation policy to be additionally specified by the user, the policy display unit 11 gets back to the process at step S101. Generally, a simple task can be executed with a single policy, but for a task which needs complex operation, multiple policies need to be set. Therefore, in order to set a plurality of policies, the policy display unit 11 repeatedly executes the processes at step S101 to step S103.

Next, the policy acquisition unit 21 acquires, from the policy display unit 11, information indicating the operation policy, the state variables, and the learning target parameters specified at step S101 to step S103 (step S105).

Next, the parameter determination unit 22 determines an initial value (i.e., a tentative value) of each learning target parameter of the operation policy acquired at step S105 (step S106). For example, the parameter determination unit 22 may determine the initial value of each learning target parameter to a value randomly determined from the value range of the each learning target parameter. In another example, the parameter determination unit 22 may use a predetermined value (i.e., a predetermined value stored in a memory to which the parameter determination unit 22 can refer) preset in the system as the initial value of each learning target parameter. The parameter determination unit 22 also determines the values of the parameters of the operation policy other than the learning target parameters in the same way.

Next, the policy combining unit 23 generates a control command to the robot by combining the operation policies based on each operation policy and corresponding state variable obtained at step S105 and the value of the each learning target parameter determined at step S106 (step S107). The policy combining unit 23 outputs the generated control command to the robot hardware 300.

Since the value of the learning target parameter for each operation policy determined at step S106 is a tentative value, the control command generated based on the tentative value of the learning target parameter does not necessarily allow the robot to perform the actually desired operation. In other words, the initial value of the parameter to be learned, which is determined at step S106 does not necessarily maximize the reward immediately. Therefore, the robot system 1 evaluates the actual operation by executing the processes at step S108 to step S111 to be described later, and updates the learning target parameters of the respective operation policies.

First, the evaluation index display unit 13 receives the input from the user specifying the evaluation index (step S108). The process at step S108 may be performed at any timing by the time the process at step S110 is executed. As an example, FIG. 3 indicates the case where the process at step S108 is executed at the timing independent from the timing of the process flow at step S101 to step S107. It is noted that the process at step S108 may be performed, for example, after the processes at step S101 to step S103 (i.e., after the determination of the operation policies). Then, the evaluation index acquisition unit 24 acquires the evaluation index set by the operator (step S109).

Next, the state evaluation unit 26 calculates the reward value for the operation of the robot with the learning target parameter tentatively determined (i.e., the initial value) on the basis of the sensor information generated by the sensor 32 and the evaluation index acquired at step S109 (step S110). Thus, the state evaluation unit 26 evaluates the result of the operation of the robot controlled based on the control command (control input) calculated at step S107.

Hereafter, the period from the beginning of operation of the robot to the evaluation timing at step S110 is called “episode”. It is noted that the evaluation timing at step S110 may be the timing after a certain period of time has elapsed from the beginning of the operation of the robot, or may be the timing in which the state variable satisfies a certain condition. For example, in the case of a task in which the robot handles an object, the state evaluation unit 26 may terminate the episode when the hand of the robot is sufficiently close to the object and evaluate the cumulative reward (the cumulative value of the evaluation index) during the episode. In another example, when a certain time elapses from the beginning of the operation of the robot or when a certain condition is satisfied, the state evaluation unit 26 may terminate the episode and evaluate the cumulative reward during the episode.

Next, the parameter learning unit 25 learns the value of the learning target parameter to maximize the reward value based on the initial value of the learning target parameter determined at step S106 and the reward value calculated at step S110 (step S111). For example, as one of the simplest approaches, the parameter learning unit 25 gradually changes the value of the learning target parameter in the grid search and obtains the reward value (evaluation value) thereby to search for the learning target parameter to maximize the reward value. In another example, the parameter learning unit 25 may execute random sampling for a certain number of times, and determine the updated value of the learning target parameter to be the value of the learning target parameter at which the reward value becomes the highest among the reward values calculated by each sampling. In yet another example, the parameter learning unit 25 may use the history of the learning target parameters and the corresponding reward value to acquire the value of the learning target parameter to maximize the reward value based on Bayesian optimization.

The values of the learning target parameters learned by the parameter learning unit 25 are supplied to the parameter determination unit 22, and the parameter determination unit 22 supplies the values of the learning target parameters supplied from the parameter learning unit 25 to the policy combining unit 23 as the updated value of the learning target parameters. Then, the policy combining unit 23 generates a control command based on the updated value of the learning target parameter supplied from the parameter determination unit 22 and supplies the control command to the robot hardware 300.

(3-2) Details of Processes at Step S101 to S103

A detailed description of the process of inputting the information on the operation policy specified by the user at step S101 to step S103 in FIG. 3 will be described. First, a specific example regarding the operation policy will be described.

The “operation policy” specified at step S101 is a transformation function of an action according to a certain state variable, and more specifically, is a control law to control the target state at a point of action of the robot according to the certain state variable. It is noted that examples of the “point of action” include a representative point of the end effector, a fingertip, each joint, and an arbitrary point (not necessarily on the robot) offsetted from a point on the robot. Further, examples of the “target state” include the position, the velocity, the acceleration, the force, the posture, and the distance, and it may be represented by a vector. Hereafter, the target state regarding a position is referred to as “target position” in particular.

Further, Examples of the “state variable” include any of the following (A) to (C).

(A) The value or vector of the position, the velocity, the acceleration, the force, or the posture of the point of action, an obstacle, or an object to be manipulated, which are in the workspace of the robot.
(B) The value or vector of the difference in the position, the velocity, the acceleration, the force, or the posture of the point of action, an obstacle, or an object to be manipulated, which are in the workspace of the robot.
(C) The value or vector of a function whose argument is (A) or (B).

Typical examples of the type of the operation policy include attraction, retention, and retention. The “attraction” is a policy to approach a set target state. For example, provided that an end effector is selected as a point of action, and that the target state is a state in which the end effector is in a position in space, and that the policy is set to attraction, the robot controller 200 determines the operation of each joint so that the end effector approaches its target position. In this case, the robot controller 200 sets a virtual spring which provides a force between the target position and the position of the end effector to make the end effector approach the target position, and generates a velocity vector based on the spring force, and solves the inverse kinematics, thereby calculating the angular velocity of each joint subjected to generation of the velocity vector. The robot controller 200 may determine the output of the joints based on a manner such as RMP (Riemannian Motion Policy), which is a manner similar to inverse kinematics.

The “avoidance” is a policy to prevent a certain state variable (typically, an obstacle's position) from approaching the point of action. For example, when an avoidance policy is set, the robot controller 200 sets a virtual repulsion between an obstacle and a point of action and obtains an output of a joint that realizes it by inverse kinematics. Thus, the robot can operate as if it were avoiding obstacles.

The “retention” is a policy to set an upper limit or a lower limit for a state variable and make the state variable stay within that range determined thereby. For example, if a policy of a retention is set, the robot controller 200 may generate a repulsion (repelling force), like avoidance, to the boundary at the upper limit or the lower limit, which causes the target state variable to stay within the predetermined range without exceeding the upper limit or lower limit.

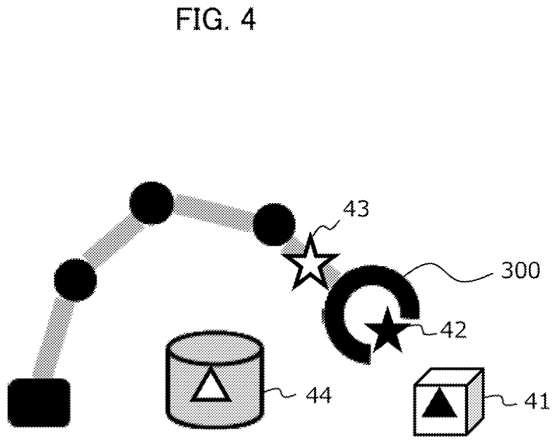

Next, a description will be given of a specific example of the processes at step S101 to step S103 with reference to FIG. 4. FIG. 4 is a diagram illustrating an example of the surrounding environment of the robot hardware 300 that is assumed in the first example embodiment. In the first example embodiment, as shown in FIG. 4, around the robot hardware 300, there are an obstacle 44 which is an obstacle for the operation of the robot hardware 300, and a target object 41 to be grasped by the robot hardware 300.

At step S101, the policy display unit 11 inputs a user input to select the type of the operation policy suitable for the task from the candidates for the type of operation policy such as attraction, avoidance, or retention. Hereafter, it is assumed that the type of the operation policy (first operation policy) firstly specified in the first example embodiment is attraction.

At step S101, the policy display unit 11 inputs an input to selects the point of action of the first operation policy. In FIG. 4, the selected point of action 42 of the first operation policy is indicated explicitly by the black star mark. In this case, the policy display unit 11 inputs an input to select the end effector as the point of action of the first operation policy. In this instance, the policy display unit 11 may display, for example, a GUI (Graphic User Interface) showing the entire image of the robot to input the user input to select the point of action on the GUI. The policy display unit 11 may store in advance one or more candidates for the point of action of the operation policy for each type of the robot hardware 300, and select the point of action of the operation policy from the candidates based on the user input (automatically when the candidate is one).

At step S102, the policy display unit 11 selects the state variable to be associated with the operation policy specified at step S101. In the first example embodiment, it is assumed that the position (specifically, the position indicated by the black triangle mark) of the target object 41 shown in FIG. 4 is selected as the state variable (i.e., the target position with respect to the point of action) to be associated with the attraction that is the first operation policy. Namely, in this case, such an operation policy is set that the end effector (see the black star mark 42) which is the point of action is attracted to the position of the object. The candidates for the state variable may be associated with the operation policy in advance in the policy storage unit 27 or the like.

At step S103, the policy display unit 11 inputs (receives) an input to select a learning target parameter (specifically, not the value itself but the type of the learning target parameter) in the operation policy specified at step S101. For example, the policy display unit 11 refers to the policy storage unit 27 and displays the parameters, which are selectable by the user, associated with the operation policy specified at step S101 as candidates for the learning target parameter. In the first example embodiment, the gain (which is equivalent to the spring constant of a virtual spring) of the attraction policy is selected as the learning target parameter in the first operation policy. Since the way of convergence to the target position is determined by the value of the gain of the attraction policy, this gain must be appropriately set. Another example of the learning target parameter is an offset to the target position. If the operation policy is set according to the RMP and the like, the learning target parameter may be a parameter that defines the metric. Further, when the operation policy is implemented with a virtual potential according to the potential method or the like, the learning target parameter may be a parameter of the potential function.

The policy display unit 11 may also input (receive) an input to select a state variable to be the learning target parameter from the possible state variables associated with the operation policy. In this case, the policy display unit 11 notifies the policy acquisition unit 21 of the state variable specified by the user input as the learning target parameter.

When a plurality of operation policies are to be set, the policy display unit 11 repeats the processes at step S101 to step S103. In the first example embodiment, the avoidance is set as the type of the operation policy (the second operation policy) that is set as the second. In this instance, the policy display unit 11 receives an input to specify the avoidance as the type of the operation policy at step S101, and receives an input to specify the root position (i.e., the position indicated by the white star mark in FIG. 4) of the end effector of the robot arm as the point of action 43 of the robot. In addition, at step S102, the policy display unit 11 receives, as the state variable, an input to specify the position (i.e., the position indicated by the white triangle mark) of the obstacle 44, and associates the specified position of the obstacle 44 with the second operation policy as a target of avoidance. By setting the second operation policy and the state variable as described above, a virtual repulsion from the obstacle 44 occurs at the root (see white star mark 43) of the end effect. Then, in order to satisfy it, the robot controller 200 determines the output of each joint based on inverse kinematics or the like to thereby generate the control command to operate the robot hardware 300 so that the root of the end effector avoids the obstacle 44. In the first example embodiment, the policy display unit 11 receives the input to select the coefficient of the repulsion as the learning target parameter for the second operation policy. The coefficient of repulsion determines how far the robot will avoid the obstacle 44.

After setting all the operation policies, the user selects, for example, a setting completion button displayed by the policy display unit 11. In this instance, the robot controller 200 receives from the policy display unit 11 the notification indicating that the setting completion button is selected. Then, the robot controller 200 determines that the designation relating to the operation policy has been completed at step S104, and proceeds with the process at step S105.

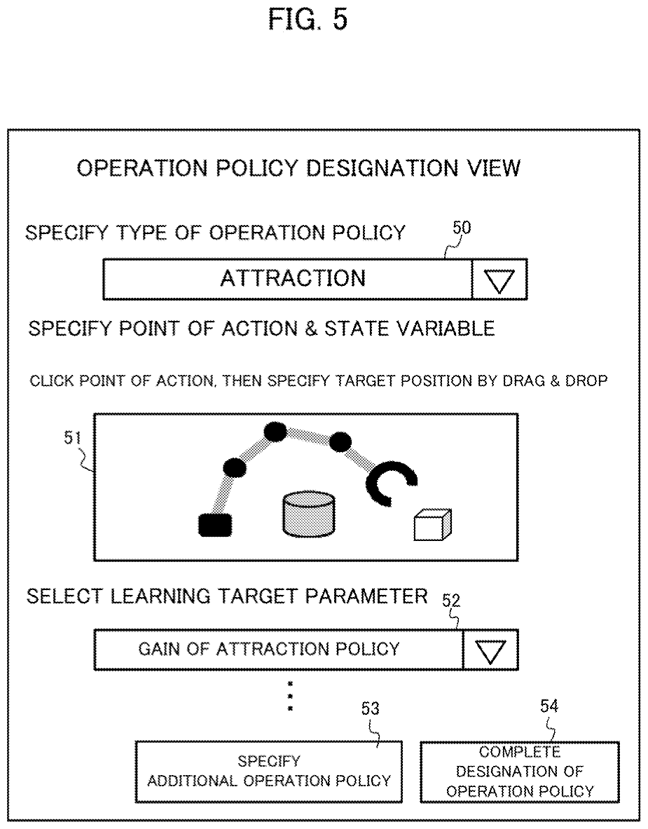

FIG. 5 is an example of the operation policy designation screen image displayed by the policy display unit 11 in the first example embodiment based on the processes at step S101 to S103. The operation policy designation screen image includes an operation policy type designation field 50, a point-of-action/state variable designation field 51, learning target parameter designation fields 52, an additional operation policy designation button 53, and an operation policy designation completion button 54.

The operation policy type designation field 50 is a field to select the type of the operation policy, and, as an example, is herein according to a pull-down menu format. In the point-of-action/state variable designation field 51, for example, computer graphics based on the sensor information from the sensor 32 or an image in which the task environment is photographed is displayed. For example, the policy display unit 11 identifies the point of action to be the position of the robot hardware 300 or the position in the vicinity thereof corresponding to the pixel specified by click operation in the point-of-action/state variable designation field 51. The policy display unit 11 further inputs the designation of the target state of the point of action by, for example, drag-and-drop operation of the specified point of action. The policy display unit 11 may determine the information which the user should specify in the point-of-action/state variable designation field 51 based on the selection result in the operation policy type designation field 50.

The learning target parameter designation field 52 is a field of selecting the learning target parameter for the target operation policy, and conforms to a pull-down menu format. Plural learning target parameter designation fields 52 are provided and input the designation of plural learning target parameters. The additional operation policy designation button 53 is a button for specifying an additional operation policy. When detecting that the additional operation policy designation button 53 is selected, the policy display unit 11 determines that the designation has not been completed at step S104 and newly displays an operation policy designation screen image for specifying the additional operation policy. The operation policy designation completion button 54 is a button to specify the completion of the operation policy designation. When the policy display unit 11 detects that the operation policy designation completion button 54 has been selected, it determines that the designation has been completed at step S104, and proceeds with the process at step S105. Then, the user performs an inputs to specify the evaluation index.

(3-3) Details of Process at Step S107

Next, a supplemental description will be given of the generation of the control command to the robot hardware 300 by the policy combining unit 23.

For example, if the respective operation policies are implemented in inverse kinematics, the policy combining unit 23 calculates the output of respective joints in the respective operation policies for each control period and calculates the linear sum of the calculated output of the respective joints. Thereby, the policy combining unit 23 can generate a control command that causes the robot hardware 300 to execute an operation such that the respective operation policies are combined. As an example, it is hereinafter assumed that there are set such a first operation policy that the end effector is attracted to the position of the target object 41 and such a second operation policy that the root position of the end effector avoids the obstacle 44. In this case, the policy combining unit 23 calculates the output of each joint based on the first operation policy and the second operation policy for each control period, and calculates the linear sum of the calculated outputs of the respective joints. In this case, the policy combining unit 23 can suitably generate a control command to instruct the robot hardware 300 to perform a combined operation so as to avoid the obstacle 44 while causing the end effector to approach the target object 41.

At this time, each operation policy may be implemented based on a potential method, for example. In the case of the potential method, the combining is possible, for example, by summing up the values of the respective potential functions at each point of action. In another example, the respective operation policies may be implemented based on RMP. In the case of RMP, each operation policy has a set of a virtual force in a task space and Riemannian metric that acts like a weight for the direction of the action when combined with other operation policies. Therefore, in RMP, it is possible to flexibly set how the respective operation policies are added when plural operation policies are combined.

Accordingly, the control command to move the robot arm is calculated by the policy combining unit 23. The calculation of the output of each joint in each operation policy requires information on the position of the target object 41, the position of the point of action, and the position of each joint of the robot hardware 300. For example, the state evaluation unit 26 recognizes the above-mentioned information on the basis of the sensor information supplied from the sensor 32 and supplies the information to the policy combining unit 23. For example, an AR marker or the like is attached to the target object 41 in advance, and the sate evaluation unit 26 may measure the position of the target object 41 based on an image taken by the sensor 32 included in the robot hardware such as a camera. In another example, the state evaluation unit 26 may perform inference of the position of the target object 41 from an image or the like obtained by photographing the robot hardware 300 by the sensor 32 without any marker using a recognition engine such as deep learning. The state evaluation unit 26 may calculate, according to the forward kinematics, the position or the joint position of the end effector of the robot hardware 300 from each joint angle and the geometric model of the robot.

(3-4) Details of Process at Step S108

At step S108, the evaluation index display unit 13 receives from the user the designation of the evaluation index for evaluating the task. Here, in FIG. 4, when a task is to cause the fingertip of the robot hardware 300 to approach the target object 41 while avoiding the obstacle 44, as an evaluation index for that purpose, for example, such an evaluation index is specified that the faster the velocity of the fingertip of the robot hardware 300 toward the target object 41 is, the higher the reward becomes.

Further, since the robot hardware 300 should not hit the obstacle 44, it is desirable to specify the evaluation index such that the reward is lowered by hitting the obstacle 44. In this case, for example, the evaluation index display unit 13 receives a user input to additionally set the evaluation index such that the reward value decreases with an occurrence of an event that the robot hardware 300 is in contact with the obstacle 44. In this case, for example, while the fingertip of the robot reaches the object as quickly as possible, the reward value for an operation without hitting the obstacle is maximized. In addition, examples of the target of the selection at step S108 include an evaluation index to minimize the jerk of the joint, an evaluation index to minimize the energy, and an evaluation index to minimize the sum of the squares of the control input and the error. The evaluation index display unit 13 stores information indicating candidates for the evaluation index in advance, and with reference to the information, and then displays the candidates for the evaluation index which are selectable by the user. Then, the evaluation index display unit 13 detects that the user has selected the evaluation index, for example, by sensing the selection of a completion button or the like on the screen image.

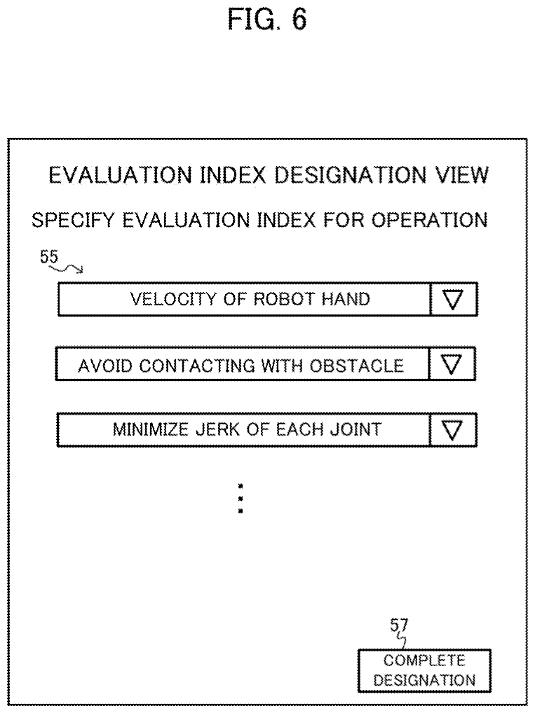

FIG. 6 is an example of evaluation index designation screen image displayed by the evaluation index display unit 13 at step S108. As shown in FIG. 6, the evaluation index display unit 13 displays, on the evaluation index designation screen image, a plurality of selection fields relating to the evaluation index for respective operation policies specified by the user. Here, the term “velocity of robot hand” refers to an evaluation index such that the faster the velocity of the hand of the robot hardware 300 is, the higher the reward becomes, and the term “avoid contact with obstacle” refers to an evaluation index in which the reward value decreases with increase in the number of occurrences that the robot hardware 300 has contact with the obstacle 44. The term “minimize jerk of each joint” refers to an evaluation index to minimize the jerk of each joint. Then, the evaluation index display unit 13 terminates the process at S108 if it detects that the designation completion button 57 is selected.

(4) Effect

By adopting the configuration and operation described above, it is possible to enable the robot to easily learn and acquire the parameters of the policy for executing a task, wherein a complicated operation is generated with a combination of simple operations and the operation is evaluated by the evaluation index.

In general, reinforcement learning using a real machine requires a very large number of trials, and it takes a very large amount of time to acquire the operation. Besides, there are demerits regarding the real machine such as overheat of the actuator due to many repetitive operations and the wear of the joint parts. In addition, the existing reinforcement learning method performs operations in a trial-and-error manner so that various operations can be realized. Thus, the types of operations to be performed when acquiring operations is hardly decided in advance.

In contrasts, in any method other than a reinforcement learning method, a skilled robot engineer adjusts the passing point of the robot one by one with taking time. This leads to abrupt increase in the man-hour of the engineering.

In view of the above, in the first example embodiment, a few simple operations are prepared in advance as operation policies, and only the parameters thereof are searched for as the learning target parameters. As a result, learning can be accelerated even if the operation is relatively complex. Further, in the first example embodiment, all setting which the user has to perform is to select the operation policy and the like which is easy to perform, whereas the adjustment to suitable parameters is performed by the system. Therefore, it is possible to reduce the man-hours of the engineering even if a relatively complicated operation is included.

In other words, in the first example embodiment, typical operations are parameterized in advance, and it is also possible to further combine those operations. Therefore, the robot system 1 can generate an operation close to a desired operation by selecting operations from a plurality of pre-prepared operations by the user. In this case, the operation in which multiple operations are combined can be generated regardless of whether or not it is under a specific condition. Moreover, in this case, it is not necessary to prepare a learning engine for each condition, and reuse and combination of certain parameterized operations are also easy. In addition, by explicitly specifying parameters (learning target parameters) to be learned during learning, the space to be used for learning is limited to reduce the learning time, and it becomes possible to rapidly learn the combined operations.

(5) Modification

In the above-described description, at least a part of information on the operation policy determined by the policy display unit 11 based on the user input or the evaluation index determined by the evaluation index display unit 13 based on the user input may be predetermined information regardless of the user input. In this case, the policy acquisition unit 21 or the evaluation index acquisition unit 24 acquires the predetermined information from the policy storage unit 27 or the evaluation index storage unit 28. For example, if the information on the evaluation index to be set for each operation policy is stored in the evaluation index storage unit 28 in advance, the evaluation index acquisition unit 24 may autonomously determine, by referring to the information on the evaluation index, the evaluation index associated with the operation policy acquired by the policy acquisition unit 21. Even in this case, the robot system 1 may generate a control command by combining the operation policies and evaluating the operation to update the learning target parameters. This modification is also preferably applied to the second example embodiment and the third example embodiment described later.

### Second Example Embodiment

Next, a description will be given of a second example embodiment that is a specific example embodiment when a task to be executed by the robot is a task to grasp a cylindrical object. In the description of the second example embodiment, the same components as in the first example embodiment are appropriately denoted by the same reference numerals, and a common description thereof will be omitted.

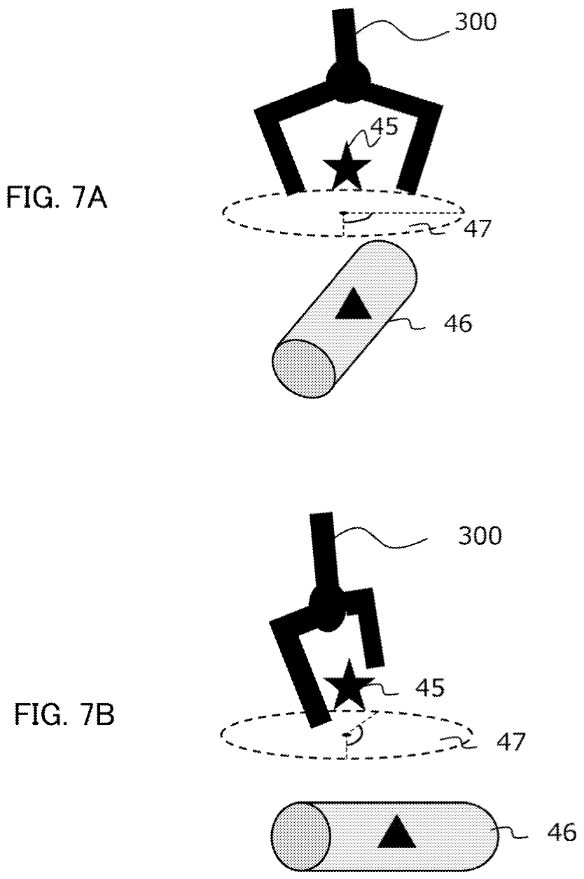

FIGS. 7A and 7B shows a peripheral view of the end effector in the second example embodiment. In FIGS. 7A and 7B, the representative point 45 of the end effector set as the point of action is shown by the black star mark. Further, the cylindrical object 46 is a target which the robot grasps.

The type of the first operation policy in the second example embodiment is attraction, and the representative point of the end effector is set as the point of action, and the position (see a black triangle mark) of the cylindrical object 46 is set as the target state of the state variable. The policy display unit 11 recognizes the setting information based on the information entered by GUI in the same way as in the first example embodiment.

In addition, the type of the second operation policy in the second example embodiment is attraction, wherein the fingertip of the end effector is set as the point of action and the opening degree of the fingers is set as the state variable and the state in which the fingers are closed (i.e., the opening degree becomes 0) is set as the target state.

In the second example embodiment, the policy display unit 11 inputs not only the designation of the operation policy but also the designation of a condition (also referred to as “operation policy application condition”) to apply the specified operation policy. Then, the robot controller 200 switches the operation policy according to the specified operation policy application condition. For example, the distance between the point of action corresponding to the representative point of the end effector and the position of the cylindrical object 46 to be grasped is set as the state variable in the operation policy application condition. In a case where the distance falls below a certain value, the target state in the second operation policy is set to a state in which the fingers of the robot are closed, and in other cases, the target state is set to the state in which the fingers of the robot are open.

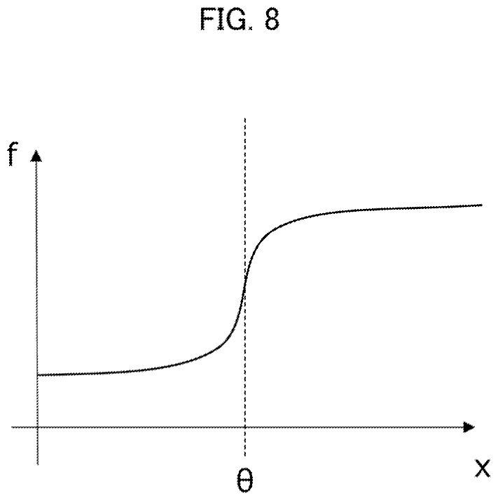

FIG. 8 is a two-dimensional graph showing the relation between the distance “x” between the point of action and the position of the cylindrical object 46 to be grasped and the state variable “f” in the second operation policy corresponding to the degree of opening of the fingers. In this case, when the distance x is greater than a predetermined threshold value “θ”, a value indicating a state in which the fingers of the robot are open becomes the target state of the state variable f, and when the distance x is less than or equal to the threshold value θ, a value indicating a state in which the fingers of the robot are closed becomes the target state of the state variable f. The robot controller 200 may smoothly switch the target state according to a sigmoid function as shown in FIG. 8, or may switch the target state according to a step function.

Furthermore, in the third operation policy, the target state is set such that the direction of the end effector is vertically downward. In this case, the end effector has a posture to grasp the target cylindrical object 46 of grip from above.

Accordingly, by setting the operation policy application condition in the second operation policy, when the first to third operation policies are combined, the robot controller 200 can suitably grasp the cylindrical object 46 by the robot hardware 300. Specifically, in such a case that the representative point of the end effector, which is the point of action, approaches, from above with the fingers open, the cylindrical object 46 to be grasped and that the representative point of the end effector is sufficiently close to the position of the cylindrical object 46, the robot hardware 300 closes the fingers to perform an operation of grasping the cylindrical object 46.

However, as shown in FIGS. 7A and 7B, it is considered that the posture of the end effector capable of grasping is different depending on the posture of the cylindrical object 46 to be grasped. Therefore, in this case, the fourth operation policy for controlling the rotation direction (i.e., rotation angle) 47 of the posture of the end effector is set. If the accuracy of the sensor 32 is sufficiently high, the robot hardware 300 approaches the cylindrical object 46 at an appropriate rotation direction (rotation angle) by associating the state of the posture of the cylindrical object 46 with this fourth operation policy.

Hereinafter, a description will be given on the assumption that the rotation direction 47 of the posture of the end effector is set as the learning target parameter.

First, the policy display unit 11 receives an input to set the rotation direction 47 which determines the posture of the end effector as the learning target parameter. Furthermore, in order to lift the cylindrical object 46, based on the user input, the policy display unit 11 sets, in the first operation policy, the operation policy application condition to be the closed state of the fingers, and sets the target position to not the position of the cylindrical object 46 but a position upward (in the z direction) by an offset of a predetermined distance from the original position of the cylindrical object 46. This operation policy application condition allows the cylindrical object 46 to be lifted after grabbing the cylindrical object 46.

The evaluation index display unit 13 sets, based on the input from the user, an evaluation index of the operation of the robot such that, for example, a high reward is given when the cylindrical object 46, that is a target object, is lifted. In this case, the evaluation index display unit 13 displays an image (including computer graphics) indicating the periphery of the robot hardware 300, and receives a user input to specify the position of the cylindrical object 46 as a state variable in the image. Then, the evaluation index display unit 13 sets the evaluation index such that a reward is given when the z-coordinate of the position of the cylindrical object 46 specified by the user input (coordinate of the height) exceeds a predetermined threshold value.

In another example, in a case where a sensor 32 for detecting an object is provided at the fingertip of the robot and is configured to detect an object, if any, between the fingers which are closed, the evaluation index is set such that a high reward is given when an object between the fingers is detected. As yet another example, an evaluation index that minimizes the degree of jerk of each joint, an evaluation index that minimizes the energy, an evaluation index that minimizes the square sum of the control input and the error, and the like may be possible targets of selection.

The parameter determination unit 22 tentatively determines the value of the rotation direction 47 that is the learning target parameter in the fourth operation policy. The policy combining unit 23 generates a control command by combining the first to fourth operation policies. Based on this control command, the representative point of the end effector of the robot hardware 300 moves closer from above while keeping the fingers open to the cylindrical object 46 to be grasped while keeping a certain rotation direction, and performs an operation of closing the fingers when it is sufficiently close to the cylindrical object 46.

The parameter (i.e., the initial value of the learning target parameter) tentatively determined by the parameter determination unit 22 is not always an appropriate parameter. Therefore, it is conceivable that the cylindrical object 46 cannot be grasped within a predetermined time, or, the cylindrical object 46 can be dropped before being lifted to a certain height although the fingertip touched the cylindrical object 46.

Therefore, the parameter learning unit 25 repeats trial-and-error operation of the rotating direction 47 which is the learning target parameter while variously changing the value of the rotating direction 47 so that the reward becomes high. In the above description, an example with a single learning target parameter has been presented, but plural learning target parameters may be set. In this case, for example, in addition to the rotation direction 47 of the posture of the end effector, a threshold value of the distance between the end effector and the target object may be specified as another learning target parameter, wherein the threshold value is used for determining an operation application condition to switch between the closing operation and the opening operation in the second operation policy described above.

Here, it is herein assumed that the learning target parameter relating to the rotation direction 47 in the fourth operation policy and the learning target parameter relating to the threshold of the distance between the end effector and the target object in the second operation policy are defined as “θ1” and “θ2”, respectively. In this case, the parameter determination unit 22 temporarily determines the values of the respective parameters, and then the robot hardware 300 executes the operation based on the control command generated by the policy combining unit 23. Based on the sensor information or the like generated by the sensor 32 that senses the operation, the state evaluation unit 26 evaluates the operation and calculates a reward value per episode.

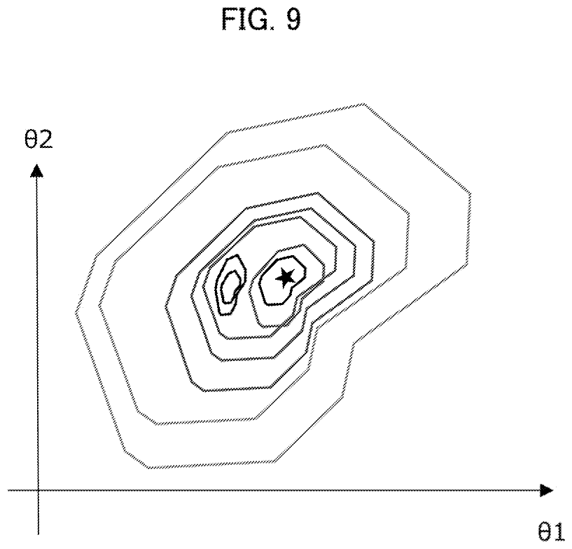

FIG. 9 illustrates a diagram in which the learning target parameters θ1 and θ2 set in each trial are plotted. In FIG. 9, the black star mark indicates the final set of the learning target parameters θ1 and θ2. The parameter learning unit 25 learns the set of values of the learning target parameters θ1 and θ2 such that the reward value becomes the highest in the parameter space. For example, as a most simplified example, the parameter learning unit 25 may search for the learning target parameters in which the reward value becomes the maximum while changing the respective learning target parameters and thereby obtaining the reward value according to the grid search. In another example, the parameter learning unit 25 may execute random sampling for a certain number of times, and determine the values of the learning target parameters at which the reward value becomes the highest among the reward values calculated by each sampling as the updated values of the learning target parameters. In yet another example, the parameter learning unit 25 may use the history of the combinations of the learning target parameters and the reward value to obtain the values of the learning target parameters which maximize the reward value based on a technique such as Bayesian optimization.

As described above, even according to the second example embodiment, by generating a complicated operation with a combination of simple operations and evaluating the operation by the evaluation index, it is possible to easily learn and acquire the learning target parameters of the operation policy for the robot to execute tasks.

### Third Example Embodiment

The robot system 1 according to the third example embodiment is different from the first and second example embodiments in that the robot system 1 sets an evaluation index corresponding to each of plural operation policies and learns each corresponding learning parameter independently. Namely, the robot system 1 according to the first example embodiment or the second example embodiment combines plural operation policies and then evaluates the combined operation to thereby learn the learning target parameters of the plural operation policies. In contrast, the robot system 1 according to the third example embodiment sets an evaluation index corresponding to each of the plural operation policies and learns each learning target parameter independently. In the description of the third example embodiment, the same components as in the first example embodiment or the second example embodiment are denoted by the same reference numerals as appropriate, and description of the same components will be omitted.

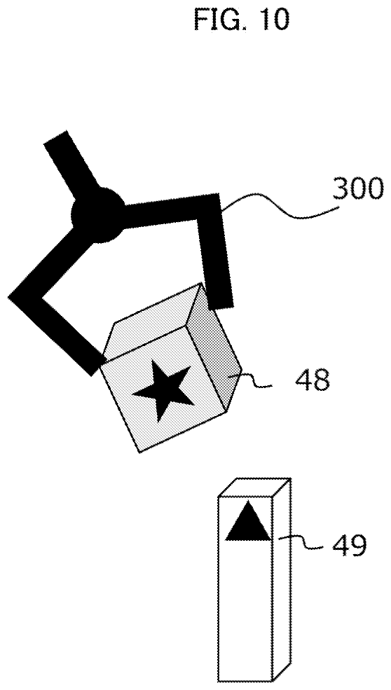

FIG. 10 shows a peripheral view of an end effector during task execution in a third example embodiment. FIG. 10 illustrates such a situation that the task of placing the block 48 gripped by the robot hardware 300 on the elongated quadratic prism 49. As a premise of this task, the quadratic prism 49 is not fixed and the quadratic prism 49 falls down if the block 48 is badly placed on the quadratic prism 49.

For simplicity, it is assumed that the robot can easily reach the state of grasping the block 48 and that the robot started the task from that state. In this case, the type of the first operation policy in the third example embodiment is attraction, and the representative point (see the black star mark) of the end effector is set as an point of action, and the representative point (see black triangle mark) of the quadratic prism 49 is set as a target position. The learning target parameter in the first operation policy is the gain of the attraction policy (corresponding to the spring constant of virtual spring). The value of the gain determines the way of the convergence to the target position. If the gain is too large, the point of action reaches the target position quickly, but the quadratic prism 49 is collapsed by momentum. Thus, it is necessary to appropriately set the gain.

Specifically, since it is desired to put the block 48 on the square field 49 as soon as possible, the evaluation index display unit 13 sets, based on the user input, the evaluation index such that the reward increases with decreasing time to reach the target position while the reward cannot be obtained if the quadratic prism 49 is collapsed. Avoiding collapsing the square field 49 may be guaranteed by a constraint condition which is used when generating a control command. In another example, the evaluation index display unit 13 may set, based on the user input, an evaluation index to minimize the degree of jerk of each joint, an evaluation index to minimize the energy, or an evaluation index to minimize the square sum of the control input and the error.

With respect to the second operation policy, the policy display unit 11 sets a parameter for controlling the force of the fingers of the end effector as a learning target parameter based on the user input. In general, in the case of attempting to place an object (i.e., block 48) on an unstable base (i.e., quadratic prism 49), the base will fall down at the time when the base comes into contact with the object if the object is held too strongly. In contrasts, if the grip force is too small, the target to carry will fall down on the way. In view of the above, it is preferable for the end effector to grasp the block 48 with the least force without dropping the target to carry. Thus, even when the quadratic prism 49 and the block 48 are in contact, the block 48 moves so as to slide in the end effector, which prevents the quadratic prism 49 from collapsing. Therefore, in the second operation policy, the parameter regarding the force of the fingers of the end effector becomes the learning target parameter.

As an evaluation index of the second operation policy, the evaluation index display unit 13 sets, based on the user input, an evaluation index such that the reward increases with decrease in the force with which the end effector holds an object while the reward is not given when the object falls down on the way. It is noted that avoiding dropping the object on the way may be guaranteed as a constraint condition which is used when generating the control command.

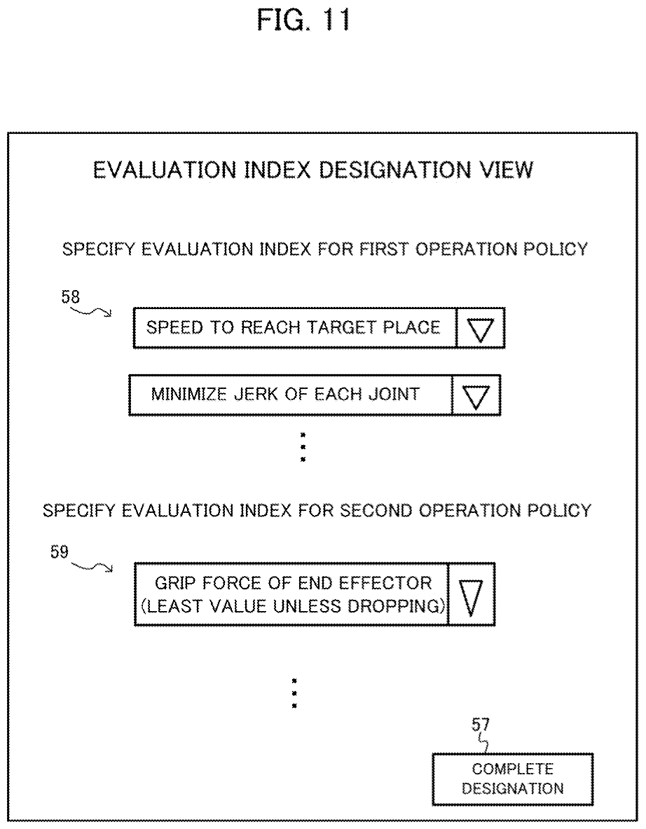

FIG. 11 is an example of an evaluation index designation screen image displayed by the evaluation index display unit 13 in the third example embodiment. The evaluation index display unit 13 receives the designation of the evaluation index for the first operation policy and the second operation policy set by the policy display unit 11. Specifically, the evaluation index display unit 13 provides, on the evaluation index designation screen image, plural first evaluation index selection fields 58 for the user to specify the evaluation index for the first operation policy, and plural second evaluation index selection fields 59 for the user to specify the evaluation index for the second operation policy. Here, the first evaluation index selection fields 58 and the second evaluation index selection fields 59 are, as an example, selection fields which conform to the pull-down menu format. The item “speed to reach target position” represents an evaluation index such that the reward increases with increasing speed to reach the target position. In addition, the item “grip force of end effector” represents an evaluation index such that the reward increases with decrease in the grip force with which the end effector holds an object without dropping it. According to the example shown in FIG. 11, the evaluation index display unit 13 suitably determines the evaluation index for each set operation policy based on user input.

The policy combining unit 23 combines the set operation policies (in this case, the first operation policy and the second operation policy) and generates the control command to control the robot hardware 300 so as to perform an operation according to the operation policy after the combination. Based on the sensor information generated by the sensor 32, the state evaluation unit 26 evaluates the operation of each operation policy based on the evaluation index corresponding to the each operation policy and calculates a reward value for the each operation policy. The parameter learning unit 25 corrects the value of the learning target parameter of the each operation policy based on the reward value for the each operation policy.

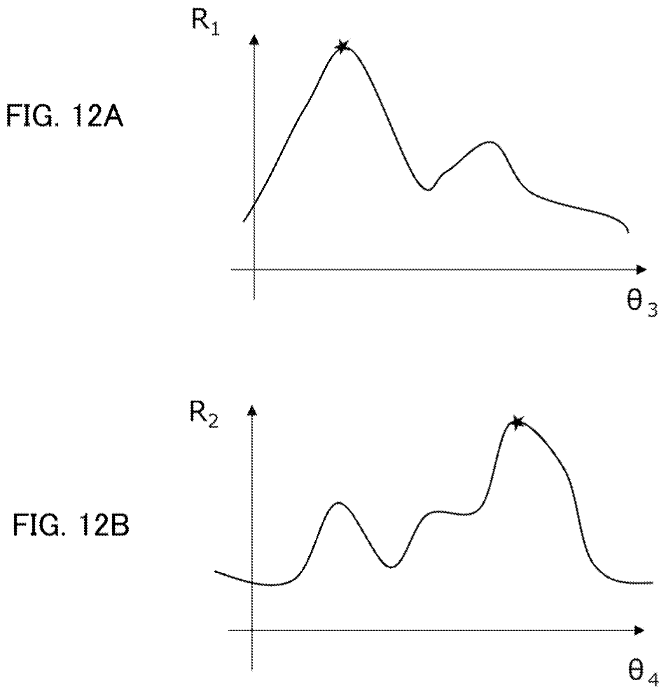

FIG. 12A is a graph showing the relation between the learning target parameter “θ3” in the first operation policy and the reward value “R1” for the first operation policy in the third example embodiment. FIG. 12B illustrates a relation between the learning target parameter “θ4” in the second operation policy and the reward value “R2” for the second operation policy in the third example embodiment. The black star mark in FIGS. 12A and 12B shows the value of the learning target parameter finally obtained by learning.

As shown in FIGS. 12A and 12B, the parameter learning unit 25 performs optimization of the learning target parameter independently for each operation policy and updates the values of the respective learning target parameters. In this way, instead of performing optimization using one reward value for a plurality of learning target parameters corresponding to a plurality of operation policies (see FIG. 9), the parameter learning unit 25 performs optimization by setting a reward value for each of the plural learning target parameters corresponding to each of the plural operation policies.

As described above, even in the third example embodiment, by generating a complicated operation with a combination of simple operations and evaluating the operation for each operation policy by the evaluation index, it is possible to easily learn and acquire the learning target parameters of the operation policies for the robot to execute tasks.

### Fourth Example Embodiment

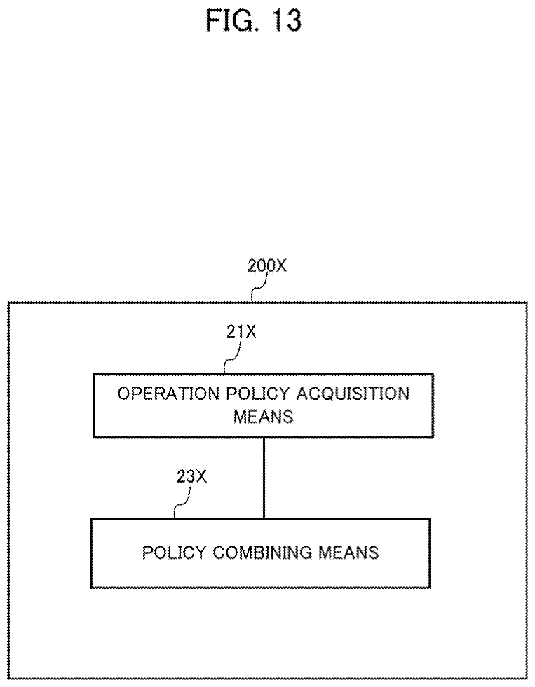

FIG. 13 shows a schematic configuration diagram of a control device 200X in the fourth example embodiment. The control device 200X functionally includes an operation policy acquisition means 21X and a policy combining means 23X. The control device 200X can be, for example, the robot controller 200 in any of the first example embodiment to the third example embodiment. The control device 200X may also include at least a part of functions of the display device 100 in addition to the robot controllers 200. The control device 200X may be configured by a plurality of devices.

The operation policy acquisition means 21X is configured to acquire an operation policy relating to an operation of a robot. Examples of the operation policy acquisition means 21X include the policy acquisition unit 21 according to any of the first example embodiment to the third example embodiment. The operation policy acquisition means 21X may acquire the operation policy by executing the control executed by the policy display unit 11 according to any of the first example embodiment to the third example embodiment and receiving the user input which specifies the operation policy.

The policy combining means 23X is configured to generate a control command of the robot by combining at least two or more operation policies. Examples of the policy combining means 23X include the policy combining unit 23 according to any of the first example embodiment to the third example embodiment.

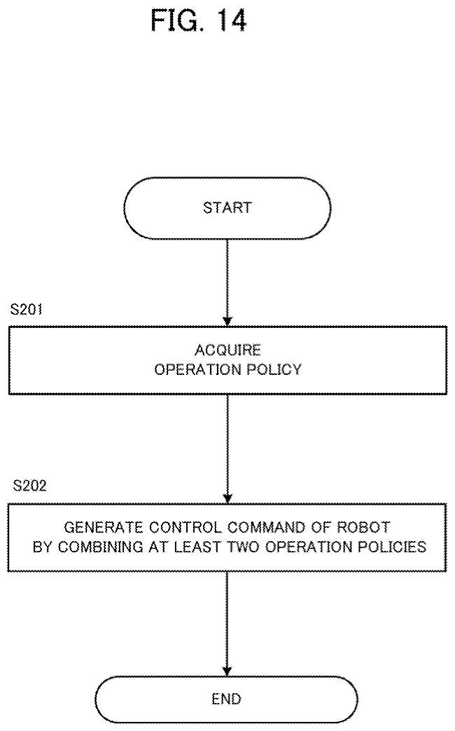

FIG. 14 is an example of a flowchart illustrating a process executed by the control device 200X in the fourth example embodiment. The operation policy acquisition means 21X acquires an operation policy relating to an operation of a robot (step S201). The policy combining means 23X generates a control command of the robot by combining at least two or more operation policies (step S202).

According to the fourth example embodiment, the control device 200X combines two or more acquired operation policies for the robot subject to control and thereby suitably generates a control command for operating the robot.

In the example embodiments described above, the program is stored by any type of a non-transitory computer-readable medium (non-transitory computer readable medium) and can be supplied to a control unit or the like that is a computer. The non-transitory computer-readable medium include any type of a tangible storage medium. Examples of the non-transitory computer readable medium include a magnetic storage medium (e.g., a flexible disk, a magnetic tape, a hard disk drive), a magnetic-optical storage medium (e.g., a magnetic optical disk), CD-ROM (Read Only Memory), CD-R, CD-R/W, a solid-state memory (e.g., a mask ROM, a PROM (Programmable ROM), an EPROM (Erasable PROM), a flash ROM, a RAM (Random Access Memory)). The program may also be provided to the computer by any type of a transitory computer readable medium. Examples of the transitory computer readable medium include an electrical signal, an optical signal, and an electromagnetic wave. The transitory computer readable medium can provide the program to the computer through a wired channel such as wires and optical fibers or a wireless channel.

The whole or a part of the example embodiments (including modifications, the same shall apply hereinafter) described above can be described as, but not limited to, the following Supplementary Notes.

[Supplementary Note 1]

A control device comprising:

an operation policy acquisition means configured to acquire an operation policy relating to an operation of a robot; and

a policy combining means configured to generate a control command of the robot by combining at least two or more operation policies.

[Supplementary Note 2]

The control device according to Supplementary Note 1, further comprising:

a state evaluation means configured to conduct an evaluation of the operation of the robot that is controlled based on the control command; and

a parameter learning means configured to update, based on the evaluation, a value of a learning target parameter which is a target parameter of learning in the operation policy.

[Supplementary Note 3]

The control device according to Supplementary Note 2, further comprising

an evaluation index acquisition means is configured to acquire an evaluation index to be used for the evaluation,

wherein the evaluation index acquisition means is configured to acquire the evaluation index selected based on a user input from plural candidates for the evaluation index.

[Supplementary Note 4]

The control device according to Supplementary Note 3,

wherein the evaluation index acquisition means configured to acquire the evaluation index for each of the operation policies.

[Supplementary Note 5]

The control device according to any one of Supplementary Notes 2 to 4,

wherein the state evaluation means is configured to conduct the evaluation for each of the operation policies based on the evaluation index for each of the operation policies, and

wherein the parameter learning means is configured to learn the learning target parameter for each of the operation policies based on the evaluation for each of the operation policies.

[Supplementary Note 6]

The control device according to any one of Supplementary Notes 2 to 5,

wherein the operation policy acquisition means is configured to acquire the learning target parameter selected based on a user input from candidates for the learning target parameter, and

wherein the parameter learning means is configured to update the value of the learning target parameter.

[Supplementary Note 7]

The control device according to any one of Supplementary Notes 1 to 6,

wherein the operation policy acquisition means is configured to acquire the operation policy selected based on a user input from candidates for the operation policy of the robot.

[Supplementary Note 8]

The control device according to Supplementary Note 7,

wherein the operation policy is a control law for controlling a target state of a point of action of the robot in accordance with a state variable, and

wherein the operation policy acquisition means is configured to acquire information specifying the point of action and the state variable.

[Supplementary Note 9]

The control device according to Supplementary Note 8,

wherein the operation policy acquisition means is configured to acquire, as a learning target parameter which is a target parameter of learning in the operation policy, the state variable which is specified as the learning target parameter.

[Supplementary Note 10]

The control device according to any one of Supplementary Notes 1 to 9,

wherein the operation policy acquisition means is configured to further acquire an operation policy application condition which is a condition for applying the operation policy, and

wherein the policy combining means is configured to generate the control command based on the operation policy application condition.

[Supplementary Note 11]

A control method executed by a computer, the control method comprising:

acquiring an operation policy relating to an operation of a robot; and

generating a control command of the robot by combining at least two or more operation policies.

[Supplementary Note 12]

A storage medium storing a program executed by a computer, the program causing the computer to:

acquire an operation policy relating to an operation of a robot; and

generate a control command of the robot by combining at least two or more operation policies.

While the invention has been particularly shown and described with reference to example embodiments thereof, the invention is not limited to these example embodiments. It will be understood by those of ordinary skilled in the art that various changes in form and details may be made therein without departing from the spirit and scope of the present invention as defined by the claims. In other words, it is needless to say that the present invention includes various modifications that could be made by a person skilled in the art according to the entire disclosure including the scope of the claims, and the technical philosophy. All Patent and Non-Patent Literatures mentioned in this designation are incorporated by reference in its entirety.

### DESCRIPTION OF REFERENCE NUMERALS

100 Display device
200 Robot controller
300 Robot hardware
11 Policy display area
13 Evaluation index display unit
21 Policy acquisition unit
22 Parameter determination unit
23 Policy combining unit
24 Evaluation index acquisition unit
25 Parameter learning unit
26 State evaluation unit
27 Policy storage unit
28 Evaluation index storage unit
31 Actuator
32 Sensor
41 Target object
42 Point of action
43 Point of action
44 Obstacle
45 Representative point of end effector
46 Cylindrical object
47 Rotation direction
48 Block
49 Quadratic prism

What is claimed is:

1. A control device comprising:
at least one memory configured to store instructions; and
at least one processor configured to execute the instructions to:
acquire an operation policy relating to an operation of a robot; and
generate a control command of the robot by combining at least two or more operation policies.

2. The control device according to claim 1,
wherein the at least one processor is configured to further execute the instructions to:
conduct an evaluation of the operation of the robot that is controlled based on the control command; and
update, based on the evaluation, a value of a learning target parameter which is a target parameter of learning in the operation policy.

3. The control device according to claim 2,
wherein the at least one processor is configured to further execute the instructions to acquire an evaluation index to be used for the evaluation, and
wherein the at least one processor is configured to execute the instructions to acquire the evaluation index selected based on a user input from plural candidates for the evaluation index.

4. The control device according to claim 3,
wherein the at least one processor is configured to execute the instructions to acquire the evaluation index for each of the operation policies.

5. The control device according to claim 2,
wherein the at least one processor is configured to execute the instructions to conduct the evaluation for each of the operation policies based on the evaluation index for each of the operation policies, and
wherein the at least one processor is configured to execute the instructions to learn the learning target parameter for each of the operation policies based on the evaluation for each of the operation policies.

6. The control device according to claim 2,
wherein the at least one processor is configured to execute the instructions to acquire the learning target parameter selected based on a user input from candidates for the learning target parameter, and
wherein the at least one processor is configured to execute the instructions to update the value of the learning target parameter.

7. The control device according to claim 1,
wherein the at least one processor is configured to execute the instructions to acquire the operation policy selected based on a user input from candidates for the operation policy of the robot.

8. The control device according to claim 7,
wherein the operation policy is a control law for controlling a target state of a point of action of the robot in accordance with a state variable, and
wherein the at least one processor is configured to execute the instructions to acquire information specifying the point of action and the state variable.

9. The control device according to claim 8,
wherein the at least one processor is configured to execute the instructions to acquire, as a learning target parameter which is a target parameter of learning in the operation policy, the state variable which is specified as the learning target parameter.

10. The control device according to claim 1,
wherein the at least one processor is configured to execute the instructions to further acquire an operation policy application condition which is a condition for applying the operation policy, and
wherein the at least one processor is configured to execute the instructions to generate the control command based on the operation policy application condition.

11. A control method executed by a computer, the control method comprising:
acquiring an operation policy relating to an operation of a robot; and
generating a control command of the robot by combining at least two or more operation policies.

12. A non-transitory computer readable storage medium storing a program executed by a computer, the program causing the computer to:
acquire an operation policy relating to an operation of a robot; and
generate a control command of the robot by combining at least two or more operation policies.
